(19) United States
(12) Patent Application Publication
(10) Pub. No.: US 2020/0023593 A1
(43) Pub. Date: Jan. 23, 2020

(54) METHOD OF MANUFACTURING HOLLOW COMPOSITE STRUCTURE

(71) Applicant: Sikorsky Aircraft Corporation, Stratford, CT (US)

(72) Inventor: Jonathan K. Garhart, Seymour, CT (US)

(21) Appl. No.: 16/199,663

(22) Filed: Nov. 26, 2018

Related U.S. Application Data
(62) Division of application No. 15/333,423, filed on Oct. 25, 2016, now abandoned.
(60) Provisional application No. 62/272,458, filed on Dec. 29, 2015.

(51) Int. Cl. B29C 65/00; B29C 65/48; B29C 70/44; B29D 22/00; B29C 70/30; B29C 65/02

(52) U.S. Cl. CPC B29C 66/81455; B29L 2031/3076; B29C 66/54; B29C 66/73753; B29C 70/44; B29D 22/00; B29C 66/73755; B29C 66/543; B29C 66/1222; B29C 66/1122; B29C 66/547; B29C 70/30; B29C 66/73751; B29C 65/02; B29C 66/634; B29C 66/636; B29C 66/1224; B29C 65/48

(57) ABSTRACT

A method of manufacturing a hollow composite structure is provided. The method includes forming a first portion of the hollow composite structure having at least one open region and at least one wall, the at least one wall partially defining a hollow interior. The method also includes bonding a laminate shell to the first portion of the hollow composite structure proximate to at least one location of the wall to cover the open region and enclose the hollow interior. The method further includes disposing a second portion of the hollow composite structure over the laminate shell, the second portion comprising a plurality of plies. The method yet further includes curing the first portion and the second portion during a final cure.

### CROSS-REFERENCE TO RELATED APPLICATIONS

This application is a divisional of U.S. patent application Ser. No. 15/333,423, filed Oct. 25, 2016, which claims priority to U.S. Provisional Application No. 62/272,458, filed Dec. 29, 2015, all of which are incorporated herein by reference in their entireties.

### FEDERAL RESEARCH STATEMENT

The content of this disclosure was made with Government support under Contract No. N00019-06-C-0081 with the United States Navy. The Government has certain rights in the application.

### BACKGROUND

The embodiments herein relate to composite structures and, more particularly, hollow composite structures and methods associated with manufacturing such structures.

In some applications, it is necessary to manufacture composite structures with a hollow or tubular topology. Molding such forms has proven challenging as the laminate must be consolidated against a tool surface on one side, often using autoclave pressure. Prior efforts have used tooling on the outer surface and an internal pressure bladder, but this approach is difficult to make reliable for thick structures. Internal tooling has been used, but must be removed, leading to complex or wash out mandrels. Fabrication over a foam mandrel may require a time consuming process of blasting the foam out after cure. Accordingly, the techniques described above pose manufacturing challenges and are often undesirable.

### BRIEF DESCRIPTION

According to one embodiment, a method of manufacturing a hollow composite structure is provided. The method includes forming a first portion of the hollow composite structure having at least one open region and at least one wall, the at least one wall partially defining a hollow interior. The method also includes bonding a laminate shell to the first portion of the hollow composite structure proximate to at least one location of the wall to cover the open region and enclose the hollow interior. The method further includes disposing a second portion of the hollow composite structure over the laminate shell, the second portion comprising a plurality of plies. The method yet further includes curing the first portion and the second portion together during a final cure.

In addition to one or more of the features described above, or as an alternative, further embodiments may include disposing a first envelope bag within the hollow interior. Also included is exerting a pressure on an inner wall of the hollow composite structure with the first envelope bag during the final cure.

In addition to one or more of the features described above, or as an alternative, further embodiments may include surrounding an outer wall of the hollow composite structure with a second envelope bag. Also included is exerting a pressure on the outer wall of the hollow composite structure with the second envelope bag during the final cure.

In addition to one or more of the features described above, or as an alternative, further embodiments may include pressurizing the hollow interior during the final cure.

In addition to one or more of the features described above, or as an alternative, further embodiments may include pressurizing the hollow interior without an envelope bag.

In addition to one or more of the features described above, or as an alternative, further embodiments may include venting the hollow interior subsequent pressurizing the hollow interior.

In addition to one or more of the features described above, or as an alternative, further embodiments may include that the first portion includes a step portion proximate the open region, wherein the laminate shell is bonded to the step portion.

In addition to one or more of the features described above, or as an alternative, further embodiments may include that disposing the plurality of plies over the laminate shell comprises disposing the plurality of plies in an overlapped manner with an outer surface of the first portion.

In addition to one or more of the features described above, or as an alternative, further embodiments may include that the laminate shell is bonded to the first portion with a paste or film adhesive.

In addition to one or more of the features described above, or as an alternative, further embodiments may include curing the laminate shell prior to bonding the laminate shell to the first portion of the hollow composite structure.

In addition to one or more of the features described above, or as an alternative, further embodiments may include applying the plurality of plies over the laminate shell after the laminate shell is bonded to the first portion of the hollow composite structure.

In addition to one or more of the features described above, or as an alternative, further embodiments may include disposing the second portion of the hollow composite structure over the laminate shell and curing the first portion and the second portion during a final cure to manufacture the hollow composite structure without a mandrel.

In addition to one or more of the features described above, or as an alternative, further embodiments may include the first portion comprising a first clam shell and the second portion comprising a second clam shell.

In addition to one or more of the features described above, or as an alternative, further embodiments may include the open region providing access to the hollow interior.

In addition to one or more of the features described above, or as an alternative, further embodiments may include the laminate shell providing an inner mold line for the second portion of the composite structure.

In addition to one or more of the features described above, or as an alternative, further embodiments may include that the hollow composite structure is complete at a completion of the final cure.

In addition to one or more of the features described above, or as an alternative, further embodiments may include that the laminate shell is bonded in an overlapped manner to an outer surface of the first portion of the composite structure.

In addition to one or more of the features described above, or as an alternative, further embodiments may include curing the first portion of the hollow composite structure during forming the first portion of the hollow composite structure.

In addition to one or more of the features described above, or as an alternative, further embodiments may include that the final cure is an overall cure of the first portion, second portion, and laminate shell.

In addition to one or more of the features described above, or as an alternative, further embodiments may include applying pressure to exterior surfaces of the hollow composite structure with a tool during the final cure.

### BRIEF DESCRIPTION OF THE DRAWINGS

The subject matter which is regarded as the present disclosure is particularly pointed out and distinctly claimed in the claims at the conclusion of the specification. The foregoing and other features and advantages of the present disclosure are apparent from the following detailed description taken in conjunction with the accompanying drawings in which:

FIG. 1 illustrates a hollow composite structure in a fully assembled condition;

FIG. 2 illustrates the hollow composite structure in a partially assembled condition;

FIG. 3 illustrates the hollow composite structure in a partially assembled condition; and

FIG. 4 illustrates the hollow composite structure in a partially assembled condition.

### DETAILED DESCRIPTION

Referring to FIG. 1, a hollow composite structure is illustrated in an assembled condition and is referenced generally with numeral 10. The composite structure 10 may be formed of numerous contemplated materials utilized in composites. Additionally, the composite structure 10 described herein may be employed in any application that benefits from the use of a hollow composite structure. In some embodiments, the composite structure 10 is employed in the aerospace industry, such as in association with a rotary wing aircraft, for example.

The composite structure 10 includes a first portion 12 that partially defines a hollow interior 14. The first portion 12 includes at least one wall that includes an inner surface that partially defines the hollow interior. In the illustrated embodiment, a first wall 16, a second wall 18 and a third wall 20 are included, but it is to be appreciated that any number of walls or wall segments may be provided depending upon the particular application. As one may readily understand, the composite structure 10 may be formed in any suitable geometry, including alternatives to that illustrated. The illustrated example is merely illustrative.

In the illustrated embodiment, the first portion 12 of the composite structure 10 may be referred to as having a “clam shell” shape. Regardless of the precise shape of the first portion 12, an open region 22 is included to provide access to the hollow interior 14. In the illustrated embodiment, an end 24 of the first wall 16 and an end 25 of the third wall 20 define the open region 22.

A laminate shell 26 is bonded to the first portion 12. The laminate shell 26 is a thin structure that provides an inner mold line for the remainder of the composite structure 10, as described herein. The laminate shell 26 is bonded to the first portion 12 in an overlapping manner at wall segments proximate to the open region 22. In the illustrated embodiment, the laminate shell 26 is bonded to the first portion 12 along an outer surface 28 of the first wall 16 and the second wall 20 to substantially cover the hollow interior 14. In some embodiments, a step portion of the at least one wall is provided proximate to the open region 22 to establish a seat to register the location of laminate shell 26. The step portion is an inwardly oriented step. In the illustrated embodiment, a first step portion 30 is located along the first wall 16 and a second step portion 32 is located along the third wall 20.

A second portion 34 of the composite structure 10 is disposed over the laminate shell 26 and cured to the laminate shell 26 and the first portion 12 in a manner that encloses the hollow interior 14 to form the hollow composite structure 10. As with the first portion 12, the second portion 34 includes at least one wall that includes an inner surface that partially defines the hollow interior. In the illustrated embodiment, a first wall 36, a second wall 38 and a third wall 40 are included, but it is to be appreciated that any number of walls or wall segments may be provided depending upon the particular application. As one may readily understand, the composite structure 10 may be formed in any suitable geometry, including alternatives to that illustrated. The illustrated example is merely illustrative. In the illustrated embodiment, the second portion 34 of the composite structure 10 may be referred to as having a “clam shell” shape.

One embodiment of the manufacturing methods described herein includes employing an envelope bag 42 within the hollow interior 14 to apply pressure along the surfaces defining the hollow interior 14 during manufacture. In such embodiments, the envelope bag 42 may remain within the finally manufactured composite structure.

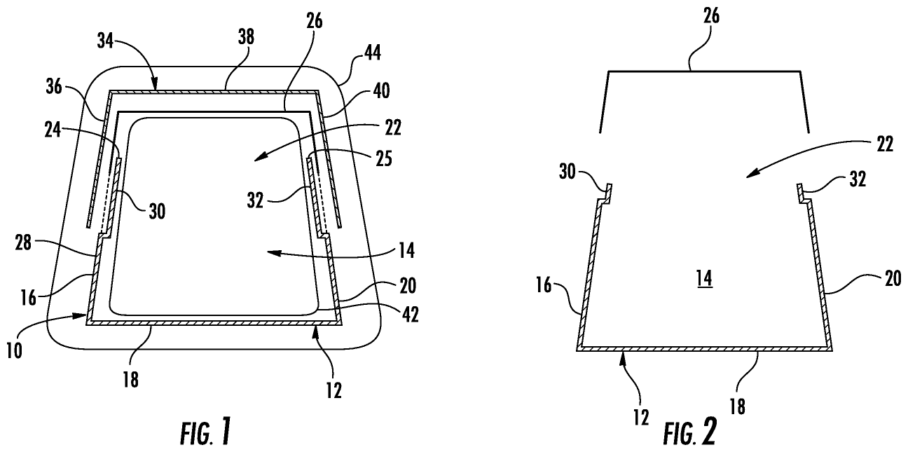

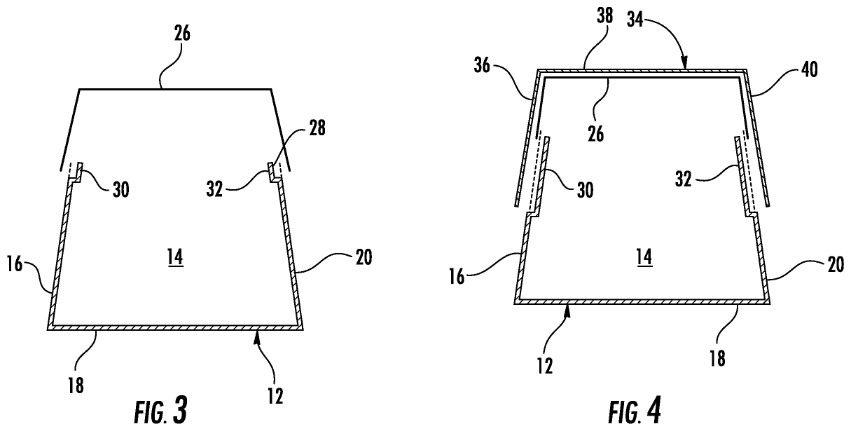

Referring now to FIGS. 2-4, the composite structure 10 is illustrated in various stages of manufacture. In particular, the first portion 12 is shown in a pre-cured condition. The first portion 12 may be formed by any suitable process. The laminate shell 26 is cured and placed in close proximity to the open region 22 of the first portion 12 (FIG. 2). The laminate shell 26 is then disposed in an overlapping manner with the outer surface 28 of the first portion 12 and bonded thereto (FIG. 3). As described above, the laminate shell 26 may be bonded to one or more step portions of the first portion 12. The bonding may be facilitated at least in part with an adhesive, such as a paste or film, for example. After the laminate shell 26 is bonded to the first portion 12, a plurality of plies that form the second component 34 of the composite structure 10 are laid up over the laminate shell 26 and cured during a final cure that establishes the overall structure of the hollow composite structure 10 (FIG. 4).

The final cure requires the application of pressure within the hollow interior 14 on inner surfaces that define the hollow interior 14. This may be done in various manners. For example, in the illustrated embodiment of FIG. 1, the envelope bag 42 may be inserted within the hollow interior 14 at an appropriate time throughout the above-described method to provide the application of pressure. Alternatively, if the hollow interior 14 is fully pressure tight, the inner pressure may be provided with pressurization and subsequently vented, thereby eliminating the need for the envelope bag 42. Regardless of the manner in which pressure is applied to the hollow interior 14, it is to be appreciated that the laminate shell 26 is not required to support pressure loads. It is provided to establish the form for the plies that form the second portion 34 of the composite structure 10.

In addition to the interior pressure application, pressure must be applied to exterior surfaces of the composite structure 10 during the final cure. This may be done with a tool or another bag 44 (FIG. 1), for example.

Advantageously, the composite structure 10 and method of manufacture described herein eliminates the need to make new wash out mandrels for each cure cycle and eliminates foam molding procedures. Additionally, no secondary operations to remove such mandrels would be required. The cured part would be complete at the end of the second autoclave cycle (i.e., first portion 12 curing and final overall cure of the first portion, second portion and laminate shell).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of manufacturing a hollow composite structure comprising:
forming a first portion of the hollow composite structure having at least one open region and at least one wall, the at least one wall partially defining a hollow interior;
bonding a laminate shell to the first portion of the hollow composite structure proximate to at least one location of the wall to cover the open region and enclose the hollow interior;
disposing a second portion of the hollow composite structure over the laminate shell, the second portion comprising a plurality of plies; and
curing the first portion and the second portion during a final cure.

2. The method of claim 1, further comprising:
disposing a first envelope bag within the hollow interior; and
exerting a pressure on an inner wall of the hollow composite structure with the first envelope bag during the final cure.

3. The method of claim 2, further comprising:
surrounding an outer wall of the hollow composite structure with a second envelope bag; and
exerting a pressure on the outer wall of the hollow composite structure with the second envelope bag during the final cure.

4. The method of claim 1, further comprising pressurizing the hollow interior during the final cure.

5. The method of claim 4, wherein pressurizing the hollow interior occurs without an envelope bag.

6. The method of claim 4, further comprising venting the hollow interior subsequent pressurizing the hollow interior.

7. The method of claim 1, the first portion including a step portion proximate to the open region, wherein the laminate shell is bonded to the step portion.

8. The method of claim 1, wherein disposing the plurality of plies over the laminate shell comprises disposing the plurality of plies in an overlapped manner with an outer surface of the first portion.

9. The method of claim 1, wherein the laminate shell is bonded to the first portion with a paste or film adhesive.

10. The method of claim 1, wherein the laminate shell is cured prior to being bonded to the first portion of the hollow composite structure.

11. The method of claim 10, wherein disposing the second portion of the hollow composite structure over the laminate shell includes applying the plurality of plies over the laminate shell after the laminate shell is bonded to the first portion of the hollow composite structure.

12. The method of claim 1, wherein disposing the second portion of the hollow composite structure over the laminate shell and curing the first portion and the second portion during a final cure to manufacture the hollow composite structure occurs without a mandrel.

13. The method of claim 1, wherein the first portion comprises a first clam shell, and the second portion comprises a second clam shell.

14. The method of claim 1, wherein the open region provides access to the hollow interior.

15. The method of claim 1, wherein the laminate shell provides an inner mold line for the second portion of the composite structure.

16. The method of claim 1, wherein the hollow composite structure is complete at a completion of the final cure.

17. The method of claim 1, wherein the laminate shell is bonded in an overlapped manner to an outer surface of the first portion of the composite structure.

18. The method of claim 1, wherein forming the first portion of the hollow composite structure includes curing the first portion of the hollow composite structure.

19. The method of claim 1, wherein the final cure is an overall cure of the first portion, second portion, and laminate shell.

20. The method of claim 1, wherein the final cure includes applying pressure to exterior surfaces of the hollow composite structure with a tool.
